(19) United States
(12) Patent Application Publication
(10) Pub. No.: US 2026/0133620 A1
(43) Pub. Date: May 14, 2026

(54) INTERACTIVE MIXED REALITY SYSTEM LEVERAGING MOBILE SENSOR DATA

(71) Applicant: Flying Flamingos India Private Limited, Bangalore (IN)

(72) Inventors: Amit Gaiki, Bangalore (IN); Shourya Agarwal, Ajmer (IN); Malhar Patil, Nagpur (IN); Divyansh Gupta, Banswara (IN)

(73) Assignee: Flying Flamingos India Private Limited, Bangalore (IN)

(21) Appl. No.: 19/388,379

(22) Filed: Nov. 13, 2025

(30) Foreign Application Priority Data
Nov. 13, 2024 (IN) 202441087823

(51) Int. Cl. G06F 3/01; G06T 19/00

(52) U.S. Cl. CPC G06F 3/011; G06T 19/006; G06T 2200/24

(57) ABSTRACT

The present disclosure provides a method, a computing system and a non-transitory computer readable storage medium for harmonizing digital objects with a physical environment. The method includes detecting a triggering action for accessing mixed reality (MR) content, activating a modular mixed reality engine in response to the detected triggering action, and receiving sensor data from at least one sensor embedded in a communication device. Further, the method includes recognizing a usage context associated with a spatial state of the communication device based on the sensor data, dynamically selecting at least one mixed reality module, and dynamically loading the at least one selected mixed reality module within a secure execution framework of the modular mixed reality engine. Moreover, the method includes rendering the mixed reality content on a display of the communication device and optimizing the rendered mixed reality content in real time based on changes in the received sensor data.

### CROSS-REFERENCE TO RELATED APPLICATIONS

The present application claims the benefit of Indian Provisional Patent Application No. 202441087823, filed Nov. 13, 2024, all of which are hereby incorporated by reference in their entirety for all purposes.

### TECHNICAL FIELD

The present disclosure relates to the field of mixed reality systems and methods. Specifically, the present disclosure relates to dynamic and adaptive rendering of mixed reality content on a communication device.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Mixed Reality (MR) technologies enable digital elements to be integrated with a user’s real-world surroundings for immersive visual experiences. Users access MR content through smartphones, tablets, head-mounted displays, or other devices equipped with cameras and sensors capable of capturing environmental and motion data. These devices allow digital objects to appear spatially anchored within physical environments and to respond to user movement in real time. However, effective real-time synchronization between physical movements and digital renderings requires adaptive processing of multi-sensor data and efficient allocation of device resources. Also, traditional mixed reality content delivery approaches depend on platform-specific applications requiring full installation on individual operating systems. Moreover, current MR systems fail to provide a truly adaptive user experience. Many of the solutions do not dynamically respond to real-time user interactions or changes in the physical environment. Accordingly, the existing solutions limit a potential of the mixed reality technologies to offer more engaging, context-aware experiences. Thus, there is a need for an invention that overcomes the above-stated disadvantages.

### SUMMARY

In a first aspect, a computing system is disclosed. The computing system is configured to enable harmonization of digital objects with a physical environment in real time. The computing system includes one or more processors and a non-transitory memory storing instructions. The instructions, when executed by the one or more processors, cause the computing system to detect a triggering action of a plurality of triggering actions for accessing mixed reality (MR) content. The instructions cause the computing system to activate a modular mixed reality engine in response to the detected triggering action. The instructions cause the computing system to receive, in real time, sensor data from a plurality of embedded sensors embedded within a communication device. The instructions cause the computing system to recognize a usage context associated with a spatial state of the communication device based on the received sensor data. The instructions cause the computing system to dynamically select at least one mixed reality (MR) module from a plurality of mixed reality modules based on the recognized usage context. The instructions cause the computing system to dynamically load the at least one selected mixed reality module within a secure execution framework of a modular mixed reality engine. The instructions cause the computing system to render a mixed reality content on a display of the communication device using the at least one selected mixed reality module, wherein the rendering includes superimposing one or more virtual elements onto a real-time view of a physical environment. The instructions cause the computing system to optimize the rendered mixed reality content in real time based on one or more changes in the received sensor data, wherein the optimizing includes at least one of adjusting a scale, position, orientation, depth alignment, or occlusion state of the one or more virtual elements relative to the physical environment. The optimization process is triggered when a pre-defined threshold change is detected in the sensor data from the at least one sensor of the plurality of embedded sensors. The one or more processors and the non-transitory memory cooperate with the plurality of embedded sensors and a display hardware of the communication device to achieve real-time synchronization of spatial data and virtual rendering operations. The real-time synchronization enables reduced rendering latency, minimized computational overhead, and enhanced real-time mixed reality performance.

In one embodiment, the plurality of embedded sensors includes at least one of an accelerometer, a gyroscope, a depth sensor, a LiDAR sensor, and a GPS sensor.

In one embodiment, the usage context includes at least one of: a linear movement detected by an accelerometer, a rotational movement detected by a gyroscope, a spatial geometry detected by a LiDAR sensor, or a geolocation detected by a GPS sensor.

In one embodiment, the optimizing of the mixed reality content includes synchronizing the one or more virtual elements with detected translational and rotational movement of the communication device to maintain spatial anchoring of the one or more virtual elements in the physical environment.

In one embodiment, the computing system utilizes the modular mixed reality engine to minimize recalculations by adaptively re-rendering mixed reality content upon detecting a threshold change in the sensor data.

In one embodiment, the plurality of triggering actions includes at least one of scanning a quick response (QR) code, detecting a near-field communication (NFC) tag, selecting a hyperlink, receiving a voice input, and recognizing a gesture input.

In one embodiment, the recognizing of the usage context includes determining a type of movement pattern of the communication device based on an accelerometer data and gyroscope data.

In one embodiment, the usage context includes a location context derived from GPS data to enable geolocation-based rendering of the mixed reality content.

In one embodiment, the optimizing of the mixed reality content includes depth-based scaling of the one or more virtual elements using distance data captured by a depth sensor or a LiDAR sensor.

In a second embodiment, the optimizing includes executing occlusion handling by detecting one or more objects in the physical environment through a LiDAR sensor or a depth sensor and adjusting rendering order.

In a third embodiment, the optimizing includes adjusting rendering fidelity of the mixed reality content based on sensor-derived device motion to reduce jitter during transitions. In one embodiment, the dynamic loading of the at least one mixed reality module includes prioritizing loading of modules based on available device resources and thresholds of sensor stability.

In one embodiment, the one or more processors are caused to execute an instruction for applying predictive motion tracking by estimating a probable movement of the communication device based on historical data from at least one of an accelerometer sensor and a gyroscope sensor. The mixed reality content is pre-adjusted based on the predictive motion tracking.

In one embodiment, the rendering includes blending a two-dimensional alpha channel video overlay with three-dimensional digital objects in spatial alignment determined by the sensor data.

In one embodiment, the plurality of mixed reality modules includes at least one of a motion tracking module, an environment mapping module, a spatial alignment module, and an occlusion handling module.

In a second aspect, a computer-implemented method is disclosed. The computer-implemented method performs harmonization of digital objects with a physical environment in real time. The computer-implemented method includes detecting a triggering action of a plurality of triggering actions for accessing mixed reality (MR) content. The computer-implemented method includes activating a modular mixed reality engine in response to the detected triggering action. In addition, the computer-implemented method includes receiving, in real time, sensor data from at least one sensor of a plurality of embedded sensors embedded within a communication device. Further, the computer-implemented method includes recognizing a usage context associated with a spatial state of the communication device based on the received sensor data. Accordingly, the computer-implemented method includes dynamically selecting at least one mixed reality module from a plurality of mixed reality modules based on the recognized usage context. Furthermore, the computer-implemented method includes dynamically loading the at least one selected mixed reality module within a secure execution framework of the modular mixed reality engine. The computer-implemented method includes rendering a mixed reality content on a display of the communication device using the at least one selected mixed reality module. The rendering includes superimposing one or more virtual elements onto a real-time view of the physical environment. Finally, the computer-implemented method includes optimizing the rendered mixed reality content in real time based on one or more changes in the received sensor data. The optimization includes at least one of adjusting a scale, position, orientation, depth alignment, or occlusion state of the one or more virtual elements relative to the physical environment. The optimization process is triggered when a pre-defined threshold change is detected in the sensor data from the at least one sensor of the plurality of embedded sensors. The execution of the stored instructions causes a hardware-level adaptation of rendering parameters and the sensor data processing across the one or more processors, a memory, and the plurality of embedded sensors of the computing device. The hardware-level adaptation improves data throughput efficiency, reduces real-time rendering latency, and enhances the mixed reality synchronization accuracy.

In a third aspect, a non-transitory computer-readable medium is provided. The non-transitory computer-readable medium stores computer-executable instructions. The instructions are executed by one or more processors of a computing device. The execution of the instructions by the one or more processors causes the computing device to perform a method for harmonization of digital objects with a physical environment in real time. The method includes detecting a triggering action of a plurality of triggering actions for accessing mixed reality (MR) content. The method includes activating a modular mixed reality engine in response to the detected triggering action. In addition, the method includes receiving, in real time, sensor data from at least one sensor of a plurality of embedded sensors embedded within a communication device. Further, the method includes recognizing a usage context associated with a spatial state of the communication device based on the received sensor data. Accordingly, the method includes dynamically selecting at least one mixed reality module from a plurality of mixed reality modules based on the recognized usage context. Furthermore, the method includes dynamically loading the at least one selected mixed reality module within a secure execution framework of the modular mixed reality engine. The method includes rendering a mixed reality content on a display of the communication device using the at least one selected mixed reality module. The rendering includes superimposing one or more virtual elements onto a real-time view of the physical environment. Finally, the method includes optimizing the rendered mixed reality content in real time based on one or more changes in the received sensor data. The optimization includes at least one of adjusting a scale, position, orientation, depth alignment, or occlusion state of the one or more virtual elements relative to the physical environment. The optimization process is triggered when a pre-defined threshold change is detected in the sensor data from the at least one sensor of the plurality of embedded sensors. The computer-implemented method causes hardware-level coordination between a processor, memory, and the plurality of embedded sensors of the communication device for real-time sensor fusion and adaptive rendering. The hardware-level coordination reduces computation latency, improves frame stability, and enhances spatial coherence between the one or more virtual elements and one or more physical elements.

### BRIEF DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 illustrates an exemplary interactive computing environment for harmonization of digital objects with a physical environment in a mixed reality experience, in accordance with various embodiments of the present disclosure;

FIG. 2 illustrates an exemplary block diagram of a computing system configured to enable the harmonization of the digital objects with the physical environment in the mixed reality experience, in accordance with various embodiments of the present disclosure;

FIG. 3 illustrates a flow chart of a method for the harmonization of the digital objects with the physical environment in the mixed reality experience, in accordance with various embodiments of the present disclosure; and

FIG. 4 illustrates a block diagram of an exemplary computing device configured for the harmonization of the digital objects with the physical environment in the mixed reality experience, in accordance with various embodiments of the present disclosure.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote features throughout the specification and figures.

### DETAILED DESCRIPTION

In the following description of the disclosure and embodiments, reference is made to the accompanying drawings in which it is shown by way of illustration of specific embodiments that can be practiced. It is to be understood that other embodiments and examples can be practiced, and changes can be made without departing from the scope of the disclosure.

Although the following description uses the terms “first,” “second,” etc. to describe various elements, these elements should not be limited by the terms. These terms are only used to distinguish one element from another. For example, a first input could be termed a second input, and, similarly, a second input could be termed a first input, without departing from the scope of the various described examples. The first input and the second input can both be outputs and, in some cases, can be separate and different inputs.

The terminology used in the description of the various described examples herein is for the purpose of describing specific examples only and is not intended to be limiting. As used in the description of the various described examples and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

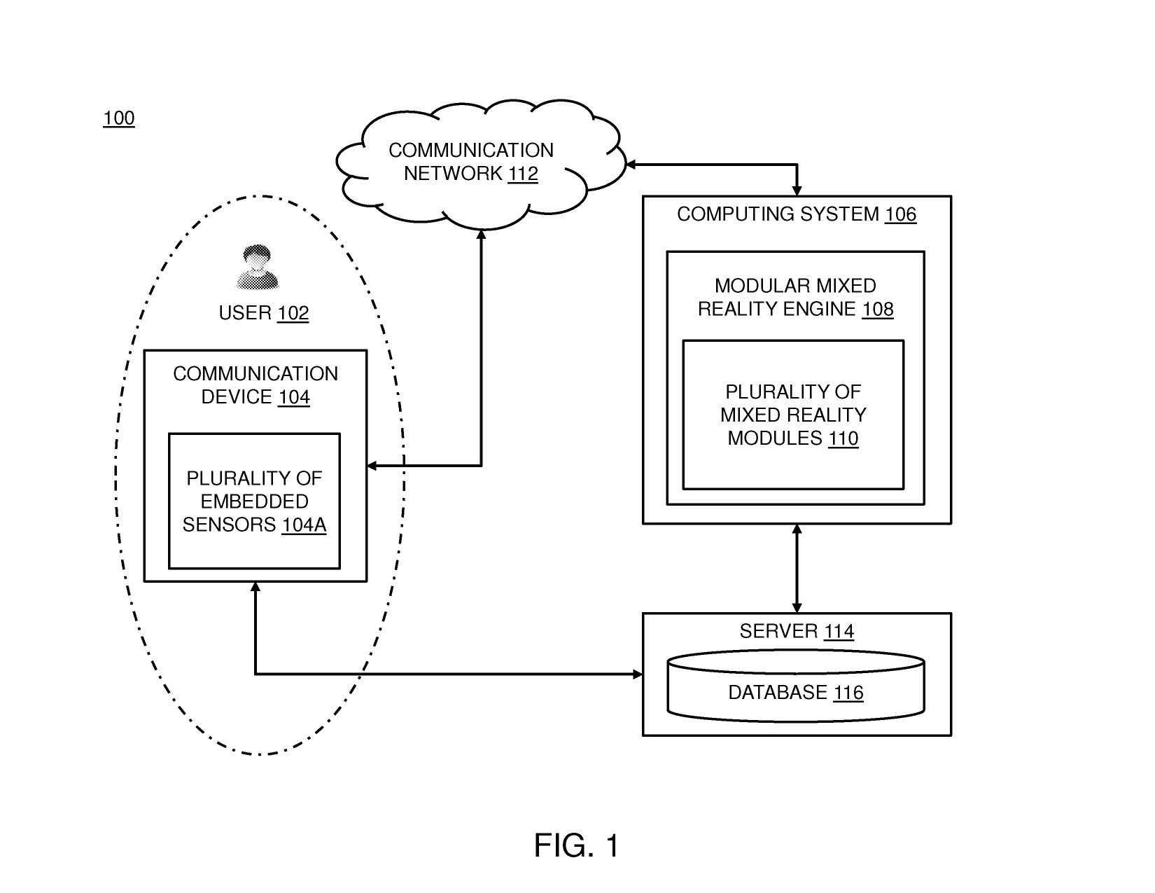

FIG. 1 illustrates an interactive computing environment 100 for sensor-driven rendering and optimization of mixed reality (MR) content, in accordance with various embodiments of the present disclosure. The interactive computing environment 100 is configured to capture sensor data from a physical environment, process the sensor data for contextual analysis, and render optimized mixed reality content on a communication device 104 associated with a user 102. The interactive computing environment 100 includes the communication device 104, a computing system 106, a communication network 112, a server 114, and a database 116. The communication device 104 interacts with the computing system 106 via the communication network 112. The components of the interactive computing environment 100 are operatively coupled and cooperatively function to enable dynamic deployment, adaptive rendering, and optimization of mixed reality content in real time. In addition, the components enable the optimization of the mixed reality content based on contextual parameters derived from a plurality of embedded sensors 104a of the communication device 104.

The mixed reality experience refers to a digitally enhanced immersive environment that blends virtual objects or augmentations with the physical environment in real time. The mixed reality experience allows the user 102 to perceive and interact with digital and physical components in a spatially and temporally coherent manner. The mixed reality content may include digital assets, virtual objects, holograms, spatial audio, interactive controls, and context-sensitive information rendered within the mixed reality experience. The rendering of mixed reality content is dynamically optimized based on user input, environmental parameters, sensor data, and device capabilities. In addition, the mixed reality content may include adaptive overlays, gesture-responsive elements, or real-world object annotations synchronized with contextual sensor inputs.

In one embodiment, the communication device 104 refers to any suitable user equipment configured to capture sensor data, receive and process contextual information, and render mixed reality content. Examples of the communication device 104 include a smartphone, tablet, smart glasses, wearable computing device, augmented reality (AR) headsets, and the like. The communication device 104 may host a runtime environment capable of executing modular mixed reality engine for sensor-driven rendering without requiring full application installation. The communication device 104 includes a plurality of embedded sensors 104a. In some embodiments, the plurality of embedded sensors 104a may include a camera sensor, a depth sensor, an inertial measurement unit (IMU), a proximity sensor, or any combination thereof. The plurality of embedded sensors 104a is configured to provide physical environment data for analysis and optimization of the mixed reality rendering.

The user 102 may represent an individual interacting with the mixed reality content through the communication device 104. The user 102 may initiate a mixed reality experience by scanning a QR code, selecting an application link, or activating a modular mixed reality engine 108 through one or more scannable or link-based mechanisms.

The computing system 106 may include one or more processors, memory units, and a rendering engine configured to generate and transmit mixed reality content to the communication device 104. The rendering engine may utilize spatial mapping data, object detection modules, and user-specific contextual inputs to adaptively harmonize the mixed reality content in real time. The communication network 112 may include wired or wireless channels such as 5G, Wi-Fi, or satellite connections, enabling low-latency synchronization and interaction of the content. The server 114 may be responsible for managing user sessions, orchestrating modular content delivery, and deploying updates. The database 116 may store user profiles, contextual information, device specifications, and pre-rendered or modular content components for on-demand execution.

In one embodiment, the computing system 106 includes a modular mixed reality engine 108. The modular mixed reality engine 108 includes a plurality of mixed reality modules 110.

In one embodiment, the modular mixed reality engine 108 corresponds to a hardware-integrated software framework configured to orchestrate the execution of the one or more mixed reality modules within the computing system 106. The modular mixed reality engine 108 interfaces directly with the processor 202, the memory 204, and the plurality of embedded sensors 104a to perform real-time computation, rendering, and spatial mapping. The modular mixed reality engine 108 acts as a middleware layer to dynamically identify, load, and execute the relevant one or more mixed reality modules based on the contextual data, the sensor inputs, and the device-specific resource parameters. The hardware-software cooperation within the modular mixed reality engine 108 enables the real-time synchronization between graphical workloads and sensor-driven inputs through optimized, hardware-assisted processing pipelines. The integration ensures adaptive allocation of the computational resources, such as CPU cycles, GPU bandwidth, and memory throughput to maintain consistent rendering stability, frame continuity, and spatial alignment between digital and physical environments.

Further, the modular mixed reality engine 108 employs kernel-level sandboxing and context-aware permission management to securely execute the one or more mixed reality modules, for ensuring operational integrity, system-level efficiency, and low-latency mixed reality content rendering. The combination of the hardware-linked optimizations enable reduced frame jitter, optimized resource utilization, and enhanced spatial coherence during the real-time mixed reality execution.

The modular mixed reality engine 108 dynamically loads at least one module of the plurality of mixed reality modules 110 in real time, based on one or more user interactions and environmental data. The dynamic module loading ensures optimized system performance and enhances user experience. In an implementation, the modular mixed reality engine 108 may be platform-agnostic and modular in architecture, enabling flexible deployment across diverse device types

In another embodiment of the present disclosure, the modular mixed reality engine 108 dynamically unloads at least one module of the plurality of mixed reality modules 110 in real time, based on user interactions and environmental conditions. The orchestration of both loading and unloading by the modular mixed reality engine 108 ensures efficient utilization of device resources, reduced latency, and improves continuity of the mixed reality experience

The plurality of mixed reality modules 110 may operate within a kernel-level application sandbox or a secure sandbox environment in a Linux-based system to ensure security and efficiency. In one embodiment, the secure sandbox environment is enabled through context-aware permission management and a secure execution framework. The sandboxing ensures both stability and protection of system resources while rendering mixed reality content.

In some embodiments, the computing system 106 enables adaptive data streaming to adjust streaming rates based on network conditions and device performance, while integrating edge computing capabilities for enhanced efficiency. Further, the computing system 106 may enable cross-module communication between at least two modules of the plurality of mixed reality modules 110 for facilitating real-time data exchange. The cross-module communication supports seamless blending of 2D alpha content with 3D environment mapping. The seamless blending enhances the realism of the rendered mixed reality experience.

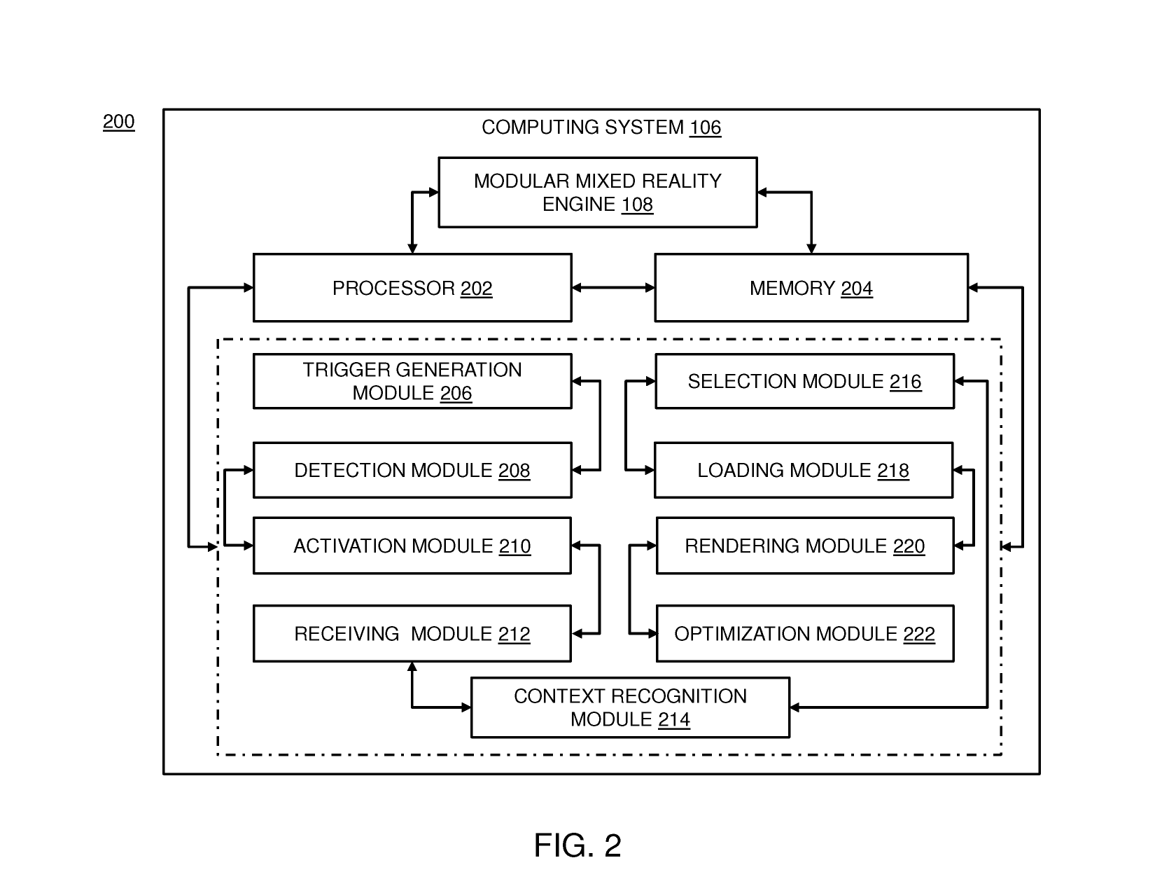

The communication device 104 works in conjunction with the computing system 106, the server 114, and the modular mixed reality engine 108 to perform a set of functions. The set of functions include at least reception of contextual data, dynamically loading appropriate one or more modules of the plurality of mixed reality modules 110, and rendering immersive mixed reality content responsive to real-time user interactions and environmental conditions (explained further below in the detailed description of FIG. 2).

The communication network 112 serves as the backbone of the interactive computing environment 100, enabling seamless communication between the communication device 104, the computing system 106, the server 114, and the database 116. Various entities in the environment 100 may connect to the communication network 112 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G), 6th Generation (6G) communication protocols, Long Term Evolution (LTE) communication protocols, future communication protocols, or any combination thereof.

The communication network 112 provides an infrastructure for seamless communication between the communication device 104, the computing system 106, the server 114, and the database 116. In some implementations, the communication network 112 includes internet, intranet, Wi-Fi, or other wired or wireless communication technologies.

The server 114 may refer to a backend processing system or a cloud-based infrastructure configured to coordinate, manage, and support the delivery of mixed reality (MR) content to the communication device 104. In some embodiments, the server 114 includes one or more computing devices configured to manage backend operations. The operations include but are not limited to, processing user requests, storing and updating mixed reality content modules, and executing cloud-based rendering operations. In addition to the above, the server 114 may manage user sessions and maintain communication with the communication device 104. The server 114 may incorporate application programming interfaces (APIs), load-balancing modules, analytics engines, and orchestration logic to dynamically coordinate mixed reality experiences across users and devices.

In some embodiments, the server 114 is associated with one or more remote computing entities. The one or more remote computing entities are responsible for facilitating core services required for managing and supporting the delivery of mixed reality (MR) experiences. The server 114 operates as an orchestrator that communicates with the computing system 106 and the communication device 104 over the communication network 112. In one example, the server 114 may host APIs, decision engines, and application services configured to process user interactions, manage MR session states, authenticate user access, and deliver relevant mixed reality content modules to downstream components.

In certain implementations, the server 114 may enforce access controls, implement deployment policies, and manage caching of frequently accessed MR assets to enhance responsiveness and delivery speed. The server 114 plays a key role in mediating communication between the modular mixed reality engine 108 on the communication device 104 and the backend infrastructure. The server 114 enables seamless synchronization and dynamic loading of the plurality of mixed reality modules 110 across heterogeneous client platforms.

In some embodiments, the server 114 and the computing system 106 are architecturally distinct but interoperable components of the interactive computing environment 100. The server 114 and the computing system 106 perform complementary functions to facilitate mixed reality content delivery and interaction. The server 114 acts as a backend orchestrator and processing layer, implemented using centralized or distributed cloud resources. In addition, the server 114 is configured to manage session states, execute intensive computational operations such as spatial computation and scene analysis, personalize mixed reality content, and transmit context-aware MR assets to client-side rendering components.

The server 114 may refer to a backend processing system or cloud-based infrastructure that coordinates, manages, and supports the rendering of the mixed reality (MR) content delivered to the communication device 104. In some embodiments, the server 114 and the computing system 106 represent architecturally distinct yet interoperable components of the interactive computing environment 100. Each of the server 114 and the computing system 106 are configured to perform complementary functions in support of mixed reality (MR) content delivery and interaction. The server 114 functions as a backend processing and orchestration layer, implemented as a cloud-based infrastructure or centralized computing resource. The server 114 is configured to manage user sessions, perform computationally intensive operations such as spatial computation, scene understanding, and mixed reality content personalization, and deliver contextually relevant MR assets to client-side components.

The server 114 may host, manage, and remotely execute an instant application mechanism for enabling the dynamic delivery of one or more mixed reality modules 110 and ensuring platform and device-independent user experiences. The server 114 may serve as an edge computing or localized processing layer that interfaces directly with the communication device 104. The server 114 is configured to handle real-time operations. The operations include at least adaptive user interface control, haptic feedback coordination, sensor data ingestion, and latency-sensitive mixed reality content rendering.

In an example implementation of a distributed computing environment and shown in FIG. 1, the computing system 106 is operatively connected to the server 114. The server 114 handles client requests and provides necessary data to the computing system 106 for further processing and rendering of mixed reality content. The computing system 106 and the server 114 are communicatively coupled via the communication network 112. The computing system 106 and the server 114 cooperatively function to enable scalable, immersive, and responsive mixed reality experiences across heterogeneous devices and usage contexts.

In another example implementation, the computing system 106 includes or is operatively connected to the database 116 for storing localized content or cached user session data (not shown in illustration). The computing system 106 is operatively connected to the server 114. The server 114 handles client requests and provides necessary data to the computing system 106 for further processing and the rendering of the mixed reality content.

The computing system 106 may include a combination of software components, processing units, microservices, or virtualized containers that handle multiple tasks. The tasks include module selection, compatibility evaluation, mixed reality asset delivery, spatial computation, and the like. The computing system 106 may represent a cloud server, an edge computing node, or a centralized processing system. The computing system 106 includes the database 116. In another embodiment, the database 116 is associated and remotely connected to the computing system 106. In one implementation, the computing system 106 may include one or more server-grade machines or distributed cloud-based computing resources configured to perform the rendering of the mixed reality (MR) content. The computing system 106 may further include a plurality of software modules and processing components operative to execute the rendering of the mixed reality (MR) content. In an example implementation scenario, the rendering may include data pre-processing, feature extraction, segmentation model inference, and post-processing operations.

The database 116 refers to one or more data storage systems that store structured and unstructured information necessary for supporting and rendering the mixed reality experience. In an example embodiment, the database 116 herein may correspond to a non-transitory storage system caused to persistently store real-time information for the rendering of the mixed reality content. The database 116 may include at least mixed reality module repositories, user profiles, mixed reality experience identifiers (IDs), device compatibility matrices, content metadata, and environmental context logs. In addition, the database 116 may contain pre-trained machine learning models used for dynamic prediction of mixed reality modules. The database 116 enables real-time data retrieval and synchronization across the computing system 106 and the server 114 to ensure that relevant mixed reality assets are efficiently selected, delivered, and rendered at the communication device 104. The database 116 may be implemented as a distributed cloud database or a hybrid architecture to support scalability, redundancy, and low-latency data access.

The database 116 herein may correspond to a collection of information in an organized manner for enabling easy access, management, and ensure the data is kept updated. In some implementations, the database 116 may include relational databases, NoSQL databases, cloud-based databases, graph databases, in-memory databases, and the like.

In an exemplary embodiment, the server 114 exists as an external host for the computing system 106 (as shown in FIG. 1). The database 116 may be integrated within the server 114. In another embodiment, the server 114 may host the computing system 106 (not shown in FIG. 1). The database 116 may be integrated within the server 114 for retrieving at least mixed reality assets, spatial data, and user interaction logs.

It is shown in FIG. 1 that a single user (the user 102) interacts with a single device (the communication device 104); however, it will be appreciated by those skilled in the art that any number of users can simultaneously interact with the corresponding communication devices in real time.

The number and arrangement of systems, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally, or alternatively, a set of systems or a set of devices of the interactive computing environment 100 may perform one or more functions described as being performed by another set of systems or another set of devices of the interactive computing environment 100.

FIG. 2 illustrates an exemplary block diagram 200 of the computing system 106 for rendering the mixed reality (MR) content at the communication device 104, in accordance with various embodiments of the present disclosure. To explain the system elements of FIG. 2, references may also be made to elements of FIG. 1 for clarity and ease of understanding.

The computing system 106 includes a processor 202, a memory 204, and the modular mixed reality engine 108. In addition, the computing system 106 includes a trigger generation module 206, a detection module 208, an activation module 210, a receiving module 212, a context recognition module 214, and a selection module 216. Moreover, the computing system 106 includes a loading module 218, a rendering module 220, and an optimization module 222. It should be noted that the above-mentioned system elements are exemplary and non-limiting; additional or alternative elements may also be incorporated within the computing system 106 in other implementations.

In some embodiments, the processor 202 corresponds to one or more hardware-based processing units configured to execute machine-readable instructions stored in the memory 204. The processor 202 may include at least one of a central processing unit (CPU), a graphics processing unit (GPU), a digital signal processor (DSP), a neural processing unit (NPU), or a combination thereof. The processor 202 performs low-level computation, instruction execution, and task scheduling to facilitate the real-time mixed reality (MR) content rendering. The processor 202 cooperates with the modular mixed reality engine 108 and the camera module 104a to process the sensor data, execute the context-recognition algorithms, and dynamically allocate the computational resources for the rendering and the optimization of the mixed reality content. The hardware-based execution of the processor 202 enables real-time frame generation, spatial tracking, and latency minimization during the display of the mixed reality content on the display of the communication device 104.

The memory 204 stores instructions that, when executed, cause the processor 202 to perform dynamic and adaptive rendering of the mixed reality (MR) content based on one or more inputs from the plurality of embedded sensors 104a in real time. The processor 202 is operably coupled with the modular mixed reality engine 108, the trigger generation module 206, the detection module 208, the activation module 210, the receiving module 212, and the context recognition module 214. Additionally, the processor 202 is in communication with the loading module 218, the rendering module 220, and the optimization module 222.

The elements of the computing system 106 collectively operate in synchronization to enable the user 102 to access and interact with the mixed reality experience. The mixed reality experience is deployed within a distributed computing environment. The distributed computing environment includes the communication device 104, a local execution system integrated with the modular mixed reality engine 108, and the server 114 operably coupled with the database 116. The computing system 106 executes within a transient runtime on the communication device 104. In addition, the computing system 106 is configured to selectively render mixed reality content based on metadata and execution of one or more instructions. The computing system 106 receives the one or more instructions from the server 114 in response to one or more triggering actions generated at the trigger generation module 206.

The processor 202 executes one or more instructions stored in the memory 204 to enable the user 102 to access the mixed reality content rendered on the communication device 104.

The trigger generation module 206 is configured to generate a plurality of access triggers. The plurality of access triggers include an image trigger, a URL trigger, a scannable code-based trigger such as a quick response (QR) code, a video trigger, and similar mechanisms. The trigger generation module 206 generates universal links that are compatible with heterogeneous devices and operating systems. In one implementation, the trigger generation module 206 generates Uniform Resource Locators (URLs) or Uniform Resource Identifiers (URIs) adhering to standardized web protocols.

The processor 202 executes instructions that cause the trigger generation module 206 to activate the plurality of embedded sensors 104a of the communication device 104. The plurality of embedded sensors 104a is triggered upon detection of a triggering action selected from a plurality of triggering actions. The detection of the triggering action initiates access to the mixed reality experience.

The detection module 208 detects a triggering action of the plurality of triggering actions for accessing the mixed reality (MR) content at the communication device 104. The plurality of triggering actions includes at least scanning a quick response (QR) code, detecting a near-field communication (NFC) tag, selecting a hyperlink, receiving a voice input, or recognizing a gesture input. In some embodiments, the QR code is captured using the plurality of embedded sensors 104a of the communication device 104, decoded, and the extracted metadata is utilized for initializing the modular mixed reality engine 108.

Each of the plurality of triggering actions provides a mechanism for the user 102 to initiate access to the mixed reality content on the communication device 104. The triggering actions enable device-agnostic and platform-agnostic access to the mixed reality content. The triggering actions support interoperability across heterogeneous devices without requiring device-specific configurations. In some embodiments, detecting a hyperlink selection at the communication device 104 initiates loading of metadata linked to the hyperlink for activating the modular mixed reality engine 108. The metadata includes at least one of a mixed reality experience identifier, asset locations, or one or more parameters governing execution of the MR experience.

In some embodiments, detection of the NFC tag through the communication device 104 includes establishing a near-field communication session, retrieving data stored on the NFC tag, and using the retrieved data to activate the modular mixed reality engine 108. In one embodiment, each triggering action is associated with a universal access link compatible with hardware capabilities of the communication device 104 and environmental data. The universal access link includes metadata embedded in the triggering action. The metadata includes at least one of an MR experience identifier, asset locations, or one or more execution parameters of the MR experience.

In one example implementation, the detection module 208 embeds the access links into mediums such as QR codes, NFC tags, or hyperlinks delivered via digital communication platforms. For instance, a QR code placed next to an exhibit in a museum may be scanned by a visitor using the communication device 104 to instantly activate an MR experience associated with that exhibit without requiring application installation.

The scanning of the QR code includes capturing an image of the QR code using the plurality of embedded sensors 104a of the communication device 104, decoding the captured image to extract encoded information, and activating the modular mixed reality engine 108 using the extracted information. Similarly, selecting a hyperlink initiates a process of loading metadata linked to the hyperlink for activating the modular mixed reality engine 108. Additionally, detection of the NFC tag through the communication device 104 includes retrieving tag data during the established NFC session and utilizing the retrieved data to activate the modular mixed reality engine 108.

The activation module 210 is configured to activate the modular mixed reality engine 108 in response to a detected triggering action. The activation module 210 initializes the execution framework of the modular mixed reality engine 108. Accordingly, the activation module 210 prepares or sends a signal to the modular mixed reality engine 108 to receive and process the sensor data in real time. The activation involves loading a secure execution environment that allows dynamic allocation of mixed reality modules 110 without requiring a pre-installed full-scale application. Further, the activation module 210 validates the metadata extracted from the triggering action. The metadata may include a mixed reality experience identifier or environmental context parameters, to ensure that the appropriate MR session is initiated.

In an implementation, the activation module 210 may allocate initial system resources including processor cycles, memory segments, and communication channels to support immediate rendering operations. The allocation enables a seamless and low-latency transition from trigger detection to mixed reality content deployment at the communication device 104.

The receiving module 212 receives, in real time, sensor data from at least one sensor of the plurality of embedded sensors 104a of the communication device 104. The received sensor data is time-stamped and packaged as a synchronized data stream for downstream processing by the computing system 106. In an embodiment, the plurality of embedded sensors 104a may include an accelerometer, a gyroscope, a depth sensor, a LiDAR sensor, and a GPS sensor. The plurality of embedded sensors 104a provide motion, orientation, range, surface geometry, and geolocation information that together form the basis for contextual recognition and runtime optimization.

Further, the receiving module 212 validates basic sensor metadata on ingress. The metadata includes sensor type identifiers, sampling rate, measurement units, camera intrinsic/extrinsic parameters, and a synchronization timestamp. The receiving module 212 then applies preprocessing to the raw sensor streams, which may include per-sensor calibration correction, dark-frame or bias subtraction for image/depth sensors, sensor-specific denoising (for example, low-pass filtering for accelerometer traces), and outlier rejection for LiDAR returns. The preprocessed output is normalized to a common coordinate frame using device pose and sensor extrinsics so that sensor fusion algorithms operate on geometrically-consistent data.

To support low-latency operation on resource-constrained communication devices 104, the receiving module 212 may perform light-weight, on-device feature extraction and summarization prior to transmission to the computing system 106 or the server 114. Example feature extraction includes inertial deltas (delta-velocity, delta-angle), compressed depth patches, sparse keypoints, and low-dimensional environmental descriptors derived from a captured image. The features are encoded using efficient binary formats such as protocol buffers or compact binary frames and transmitted over the communication network 112 with TLS-level encryption for integrity and privacy. Where network or device constraints preclude full offload, the receiving module 212 supports adaptive compression—e.g., quantization, delta encoding, or region-of-interest selection—to preserve perceptually-important data while reducing bandwidth.

Sensor fusion is executed on the synchronized, preprocessed streams to produce higher-order state variables required by downstream modules. The receiving module 212 supplies fused outputs that include device pose (position and orientation), linear and angular velocity estimates, a depth map or point cloud representation of the nearby scene, and basic radiometric summaries (global brightness, estimated color temperature). Fusion techniques may employ Kalman or extended Kalman filters, complementary filters, or neural-network-based fusion layers when trained models are available, and may use monocular depth estimation models together with device-based spatial mapping frameworks to generate dense depth maps where explicit range sensors are absent.

Furthermore, the receiving module 212 computes and publishes event-level signals used by the detection module 208 and the activation module 210, for example motion-threshold events (sudden translation or rotation), stability windows (periods of sensor stability used to freeze rendering state), and geofence or location-change events for geolocation-triggered experiences. The signals enable the computing system 106 to implement determining of usage context from accelerometer and gyroscope patterns (movement type), deriving location context from GPS data, and triggering depth-based scaling or occlusion handling using depth sensor or LiDAR-derived distance measurements.

For predictive motion tracking (as described in the dependent claim relating to historical-data-based prediction), the receiving module 212 maintains a short-term history buffer of recent inertial and pose samples. The buffer is used to estimate probable device motion using motion models (e.g., constant-velocity, constant-acceleration, or learned recurrent models), and the predicted states are forwarded to the optimization module 222 so that the modular mixed reality engine 108 can pre-adjust virtual elements to reduce perceived latency and jitter.

Finally, the receiving module 212 exposes quality-of-data metrics. The data metrics include a sample rate, packet-delay-variance, signal-to-noise ratio for depth returns, and confidence scores from monocular depth estimators. The data metrics inform module prioritization and adaptive re-rendering policies, for example continuing local rendering when sensor stability thresholds are met and deferring expensive re-computations until thresholds defined in the optimization policy are exceeded. Where heavy computation is required and the communication device 104 is constrained, the receiving module 212 supports secure offload of full sensor payloads to server 114 for server-side processing and harmonization, with results returned as compact harmonization data for application by the rendering and optimization pipeline.

The context recognition module 214 is configured to recognize a usage context associated with a spatial state of the communication device 104 based on the sensor data received through the receiving module 212. The recognition of the usage context enables the computing system 106 to dynamically adapt the rendering and harmonization of mixed reality content in real time. The usage context includes detection of movement patterns, device orientation, depth perception, and geolocation factors that affect how digital objects are superimposed on the real-world environment. The context recognition module 214 interacts directly with the plurality of embedded sensors 104a. The plurality of embedded sensors 104a capture raw data associated with the communication device 104. Accordingly, the plurality of embedded sensors 104a transmit the raw data streams to the computing system 106 or the server 114 for further processing. In certain embodiments, the plurality of embedded sensors 104a may include an accelerometer, gyroscope, depth sensor and GPS sensor. The extracted data is analyzed by the context recognition module 214 to infer spatial relationships, motion patterns, and environmental conditions relevant for rendering mixed reality content with spatial coherence.

In certain embodiments, the usage context includes at least one of a linear movement detected by an accelerometer, a rotational movement detected by a gyroscope, a spatial geometry detected by a LiDAR sensor, or a geolocation detected by a GPS sensor. For example, when the accelerometer indicates a continuous forward motion combined with low gyroscope variation, the context reognition module 214 classifies the usage context as linear movement, which may be used for forward placement of virtual navigation cues. In contrast, when gyroscope data reflects continuous rotational changes with minimal translation, the context reognition module 214 identifies a rotational movement usage context, enabling mixed reality modules to lock virtual annotations to specific turning angles or rotational frames.

The plurality of embedded sensors 104a include motion sensors such as accelerometers and gyroscopes, depth sensors such as LiDAR or structured light sensors, and geolocation sensors such as GPS units. The accelerometer measures linear acceleration of the communication device 104 along three orthogonal axes. The gyroscope measures angular velocity of the communication device 104 to detect rotations. The LiDAR sensor provides depth values and point clouds representing spatial geometry of the physical environment. The GPS unit provides latitude, longitude, and altitude data for location-specific context. The context recognition module 214 fuses these multiple sensor inputs to compute the overall usage context.

In an embodiment, the usage context includes at least one of a linear movement, a rotational movement, a spatial geometry or a geolocation of the communication device 104. The accelerometer detects the linear movement of the communication device 104. The gyroscope detects the rotational movement of the communication device 104. The LiDAR sensor detects the spatial geometry of the communication device 104. The GPS sensor detects the geolocation of the communication device 104. For example, if the accelerometer data indicates consistent forward motion along one axis and the gyroscope data indicates stability in angular velocity, the usage context may be inferred as a linear walking movement. Similarly, if the LiDAR sensor identifies the presence of vertical planes within a certain range, the usage context may be inferred as an indoor environment with walls suitable for overlaying virtual elements.

In certain embodiments, the context recognition module 214 determines a type of movement pattern of the communication device 104 based on the accelerometer and gyroscope data. For example, repetitive oscillations in accelerometer readings combined with corresponding angular variations in gyroscope data may indicate that the user 102 is climbing stairs. In contrast, smooth linear acceleration combined with stable gyroscope data may indicate vehicular movement. The classification of the movement patterns enables the computing system 106 to appropriately adjust rendering parameters of the mixed reality content. The rendering parameters may include stabilization filters or motion prediction algorithms.

In certain embodiments, the context recognition module 214 derives a location context from GPS data. The location context enables geolocation-based rendering of mixed reality content. For example, if the GPS data indicates that the user 102 is located near a landmark, the computing system 106 may trigger contextual rendering of virtual annotations or overlays related to that landmark. If the GPS coordinates indicate an outdoor environment, the module may prioritize depth-based scaling to ensure that virtual objects are consistent with large-scale physical surroundings.

In certain embodiments, the context recognition module 214 utilizes a sensor fusion algorithm to combine data from accelerometers, gyroscopes, and LiDAR sensors. The fusion algorithm reduces noise and increases reliability of the detected usage context by cross-verifying sensor outputs. For instance, if accelerometer data suggests a tilt but gyroscope data contradicts the tilt observation, the fusion algorithm computes a weighted result that minimizes inconsistencies. The weighted result ensures robust recognition of the communication device’s spatial state.

In another embodiment, the modular mixed reality engine 108 dynamically selects the one or more mixed reality modules based on the detected usage context. The usage context may correspond to linear or rotational movement detected by an accelerometer or gyroscope, spatial mapping from LiDAR, or positional data obtained through GPS. Based on the recognized context, the modular mixed reality engine 108 dynamically loads an appropriate rendering module within the secure execution framework to adjust object scale, occlusion, or spatial alignment. The continuous evaluation of sensor feedback enables the adaptive rendering fidelity to allow the computing system 106 to automatically balance performance and visual quality based on real-time motion stability, lighting variation, or sensor noise levels. The adaptive responsiveness ensures visual continuity and perceptual realism even under hardware or environmental constraints.

The context recognition module 214 provides the recognized usage context as an input to the selection module 216, which dynamically selects one or more mixed reality modules 110 that are suited to the detected context. By doing so, the computing system 106 ensures that the mixed reality experience is tailored to the real-time conditions of the communication device 104 and the surrounding physical environment.

In one embodiment, the context recognition module 214 performs synchronization of multiple sensor data streams using timestamp alignment to ensure consistency in determining the spatial state of the communication device 104. For example, LiDAR depth frames may arrive at a different frequency compared to accelerometer readings. The context recognition module 214 employs interpolation and sensor fusion algorithms such as Kalman’s filter. The Kalman’s filter maintains a coherent contextual profile of the communication device’s orientation and movement in real time.

In one embodiment, the context recognition module 214 further includes predictive motion tracking to estimate probable device movement based on historical sensor data. The module maintains a buffer of recent accelerometer and gyroscope readings to generate short-term predictions of linear and rotational trajectories. The predictive motion tracking enables the computing system 106 to pre-adjust mixed reality (MR) content, reducing latency during rapid transitions and ensuring that virtual objects remain consistently anchored within the user’s field of view.

In one embodiment, the context recognition module 214 applies depth-based scaling of virtual objects using distance data captured by a depth sensor or LiDAR sensor. When the communication device 104 approaches an object, the context recognition module 214 dynamically adjusts the rendered size of the virtual object to maintain perceptual coherence with the physical environment. For example, a virtual annotation near a physical wall will automatically shrink or expand in scale proportionally to the sensed distance, and prevent distortion in perspective.

In one embodiment, the context recognition module 214 detects motion jitter or instability in sensor readings and correspondingly adjusts rendering fidelity of the mixed reality content. The context recognition module 214 may reduce polygon counts, disable high-frequency textures, or apply frame smoothing techniques when high device movement is detected. Accordingly. The context recognition module 214 ensures stability of mixed reality content visualization during abrupt or rapid device transitions.

In one embodiment, the context recognition module 214 dynamically prioritizes sensor data channels based on environmental needs. For example, in low-light conditions, depth data from LiDAR is prioritized over camera input to maintain reliable environmental mapping. Similarly, when GPS signals are weak, local inertial sensors such as accelerometers and gyroscopes are prioritized for generating the usage context.

In one embodiment, the context recognition module 214 analyzes spatial characteristics of the physical environment surrounding the communication device 104. The physical environment refers to the user’s perspective visible through the plurality of embedded sensors 104a. The analysis includes identifying reference features of the environment. The reference features may include surfaces, boundaries, and textures for anchoring the one or more virtual elements. Further, the context recognition module 214 estimates the position and orientation of the communication device 104 relative to the reference features using motion tracking techniques. The output is a spatially coherent context profile. The context recognition module 214 may be directly linked to the rendering module 220. The context recognition module 214 communicates or transmits the context profile to the rendering module 220 for alignment of the one or more virtual elements.

The selection module 216 dynamically selects at least one mixed reality (MR) module from the plurality of mixed reality modules 110 based on the recognized usage context determined by the context recognition module 214. The dynamic selection process ensures that the mixed reality content rendered on the communication device 104 is contextually relevant, spatially aligned, and computationally optimized for the current operating environment.

In one embodiment, the selection module 216 selects one or more modules from the plurality of mixed reality 110 based on pre-defined criteria in combination with the recognized usage context. The pre-defined criteria may include device type, operating system specifications, rendering capacity, sensor availability, and the like. For example, a ground tracking module may be selected when LiDAR data indicates a horizontal plane, while an object tracking module may be chosen when the camera detects a movable object.

In one embodiment, the selection module 216 prioritizes the plurality of mixed reality modules 110 based on available device resources and thresholds of sensor stability. In addition, the prioritization corresponds to a priority based loading of modules with at least two modules being selected for executing the mixed reality experience. For example, in scenarios where the communication device 104 is moving at high speed, the selection module 216 may prioritize a motion tracking module configured to stabilize rendered virtual elements by compensating for device motion. Alternatively, in scenarios where the physical environment exhibits irregular or complex spatial geometry, the selection module 216 may prioritize an environment mapping module configured to refine surface detection and alignment of virtual objects.

In one embodiment, the selection module 216 accesses metadata associated with the recognized usage context to determine which mixed reality modules are most suitable for execution. The metadata may include parameters such as device motion type (linear or rotational), location data derived from GPS, depth information from LiDAR sensors, or object proximity data.

Based on these parameters, the selection module 216 may activate a corresponding mixed reality module that ensures accurate scaling, alignment, or occlusion handling.

In some embodiments, the plurality of mixed reality modules 110 includes at least one of: a motion tracking module, an environment mapping module, a spatial alignment module, and an occlusion handling module. For example, when a user is walking through a museum and points the communication device toward a sculpture, the selection module 216 activates the spatial alignment module to ensure that a virtual annotation is precisely anchored to the sculpture’s physical position. In contrast, when the user is outdoors pointing the communication device at a street intersection, the occlusion handling module may be prioritized so that virtual navigation arrows appear behind physical vehicles or pedestrians rather than unrealistically overlapping them.

In one embodiment, the selection module 216 dynamically adapts the module selection in real time as sensor data changes. The dynamic adaptation ensures that the one or more selected mixed reality modules are executed when required. Accordingly, the dynamic adaptation conserves computational resources and reduces latency. For instance, when a user transitions from an indoor retail environment with weak GPS signals to an outdoor environment with stable geolocation data, the selection module 216 automatically deprioritizes geolocation-based modules and activates modules optimized for spatial mapping using LiDAR data. Similarly, if the accelerometer data indicates that the communication device is stationary, the motion tracking module may be disabled to reduce unnecessary processing overhead.

The loading module 218 dynamically loads the at least one selected mixed reality module from the plurality of mixed reality modules 110 into a secure execution framework of the modular mixed reality engine 108. The loading process ensures that contextually relevant modules, identified by the selection module 216, are instantiated for execution. The selective or contextual loading of modules optimizes performance, memory utilization, and response time.

In some embodiments, the loading module 218 dynamically loads the at least one selected mixed reality modules of the plurality of mixed reality modules 110. The at least one selected mixed reality modules are selected into a secure execution framework on the communication device 104. The secure execution framework corresponds to a kernel-level sandboxed environment or transient runtime environment that ensures security and performance.

In an exemplary embodiment, the secure execution framework is instantiated through an instant application mechanism of pre-defined size. The instant application provides temporary execution without requiring installation. In addition, the instant application enables efficient deployment across heterogeneous devices. For example, in a navigation MR scenario, when a user points the communication device at a landmark, a module for overlaying historical data is loaded; when the user walks away, the module is unloaded, and a navigation module is dynamically loaded instead.

In some embodiments, the loading module 218 enforces the secure execution framework to isolate the at least one selected mixed reality modules from unauthorized access or interference. The secure execution framework may include kernel-level sandboxing, containerized runtime environments, or isolated memory partitions. The secure execution framework ensures that the at least one selected mixed reality modules is executed independently without affecting the stability of other concurrently active modules or the overall computing system 106.

In some embodiments, the loading module 218 dynamically prioritizes loading of the plurality of mixed reality modules 110 based on device resource availability and contextual urgency. For example, in a scenario where a user is walking through a crowded street, the computing system 106 may prioritize loading the occlusion handling module first to ensure that virtual navigation overlays respect real-world pedestrian occlusions. In contrast, if the user is scanning an artwork in a museum, the computing system 106 prioritizes loading the spatial alignment module to precisely anchor annotations to the scanned artwork surface.

In some embodiments, the loading module 218 adapts to device-specific resource constraints. For devices with limited GPU processing power, lightweight mixed reality modules such as text annotations or 2D overlays may be loaded instead of high-fidelity 3D rendering modules. Conversely, in high-capability devices, the loading module 218 may select and load full-scale modules for real-time 3D object rendering, hologram generation, or immersive visualizations.

In some embodiments, the loading module 218 enables partial or staged loading of the plurality of mixed reality modules 110. For example, when loading an environment mapping module, a lightweight initialization sub-module may first be loaded to perform quick surface scans. Once the initial scan is completed, the module progressively loads advanced sub-modules for fine-grained geometry mapping and depth alignment. The staged approach allows the user 102 to immediately engage with the MR experience while more complex computations are executed in the background.

In some embodiments, the loading module 218 ensures cross-module compatibility through dependency management. If a motion tracking module requires input from the environment mapping module, the loading module 218 ensures that both are loaded in the correct sequence to avoid execution conflicts. For example, while rendering an outdoor navigation scene, the environment mapping module may be loaded first to establish road and surface planes, followed by the motion tracking module to synchronize virtual navigation arrows with the user’s movement trajectory.

In some embodiments, the loading module 218 performs unloading of one or more modules of the plurality of mixed reality modules 110 that are no longer required based on changing contextual inputs or user behavior. For instance, when the communication device transitions from a stationary indoor environment to a moving outdoor environment, modules optimized for indoor annotations may be unloaded and replaced by geolocation-based navigation modules. The module unloading ensures continuous optimization of system resources, and delivers context-appropriate mixed reality content.

The rendering module 220 is configured to render mixed reality (MR) content on a display of the communication device 104 using the at least one dynamically loaded mixed reality module from the plurality of mixed reality modules 110. The rendering module 220 enables the real-time superimposition of one or more virtual elements onto a live camera feed of the physical environment, ensuring perceptual coherence between the digital and physical domains or environments.

In some embodiments, the rendering module 220 generates a spatial map of the environment based on camera input to determine placement of the one or more virtual elements. The spatial map represents surfaces, textures, and reference features in real time. The rendering module aligns the one or more virtual elements with the physical environment, ensuring they rest on detected planes or conform to object curvature.

In some embodiments, the rendering module 220 also supports alpha channel video overlays. The overlays allow transparent or semi-transparent video to be superimposed over the physical environment. The overlay enables embedding of virtual characters, annotations, or interactive elements within the user’s field of view. For example, in an MR shopping application, a transparent 3D furniture overlay may be aligned with the user’s floor surface to preview placement in real time.

In some embodiments, the rendering module 220 generates a composite view by blending camera-captured frames from the communication device 104 with virtual elements generated by the mixed reality modules. The blending is executed using alpha compositing, z-buffer ordering, or luminance-weighted blending techniques. The blending ensures that digital objects appear as naturally integrated components of the physical environment.

In some embodiments, the rendering module 220 aligns the virtual elements with detected planes, surfaces, and anchor points derived from sensor data (e.g., accelerometer, gyroscope, LiDAR, depth sensor, or GPS). For example, when the communication device 104 detects a flat tabletop surface using its depth sensor, the rendering module 220 anchors a virtual vase object onto the surface, adjusting its scale and perspective in proportion to the sensed dimensions of the physical table.

In some embodiments, the rendering module 220 enables the simultaneous rendering of heterogeneous digital assets such as two-dimensional (2D) overlays, three-dimensional (3D) holographic objects, spatial audio, or interactive annotations. For example, a 2D alpha channel video overlay of an instructional guide can be displayed alongside a 3D rendered tool model, while audio annotations describe the object in real time.

In some embodiments, the rendering module 220 includes occlusion-aware rendering techniques to ensure realism in MR visualization. Using spatial data obtained from the depth sensor or LiDAR, the module identifies real-world objects that may occlude a virtual element and adjusts the rendering order accordingly. For example, if a virtual ball is rendered in front of a real- world chair, the rendering module 220 ensures that the ball disappears behind the chair when moved to mimic natural occlusion.

In some embodiments, the rendering module 220 applies depth-based scaling of virtual objects using spatial measurements captured by embedded sensors. When the communication device 104 approaches a real-world wall, a virtual annotation projected near the wall automatically resizes to maintain proportionality with the changing sensed distance. The depth-based scaling prevents distortion and maintains perceptual consistency of digital objects.

In some embodiments, the rendering module 220 optimizes rendering fidelity based on device motion detected by accelerometers and gyroscopes. For example, during high-speed device movement, the rendering module 220 reduces polygon counts, disables non-critical visual effects, or applies temporal smoothing to minimize jitter in the rendered mixed reality content. When the communication device stabilizes, the rendering module restores high-fidelity rendering for enhanced realism.

In some embodiments, the rendering module 220 supports simultaneous rendering of multiple mixed reality content layers. For instance, while navigating through a shopping mall, a virtual wayfinding arrow (3D object) can be superimposed on the floor, a 2D promotional banner can be displayed above store entrances, and contextual text labels can be anchored to real-world shop fronts—all rendered in real time and aligned with sensor data.

In some embodiments, the rendering module 220 ensures synchronization between visual rendering and interactive feedback mechanisms. For example, gesture inputs from the user 102, such as pointing at an object, may trigger real-time updates in rendered mixed reality content, allowing a virtual highlight or annotation to appear instantly.

The optimization module 222 is configured to optimize the rendered mixed reality (MR) content in real time based on changes detected in sensor data streams received from the plurality of embedded sensors 104a of the communication device 104. The optimization module 222 ensures that digital objects maintain visual coherence, spatial anchoring, and perceptual stability relative to the physical environment, even during rapid transitions or dynamic environmental changes.

In some embodiments, the optimization module 222 dynamically adjusts at least one of scale, position, orientation, depth alignment, or occlusion state of rendered virtual elements to correspond with updated sensor readings. For example, when the communication device 104 rotates suddenly, the orientation of a rendered 3D hologram is recalculated to remain aligned with the physical environment.

In some embodiments, the optimization module 222 employs a threshold-based recalibration strategy. A variation in device movement, orientation, or depth data beyond a pre-defined value triggers re-optimization of rendered mixed reality content. The optimization includes scaling of virtual objects using distance data, occlusion handling to maintain realism, and adjustment of rendering fidelity during high motion to minimize jitter.

In some embodiments, the optimization module 222 receives stabilization feedback from optical image stabilization (OIS) or electronic image stabilization (EIS) subsystems of the communication device 104. The feedback is utilized to adjust anchor points of virtual elements and to reduce jitter of rendered mixed reality content during abrupt or rapid device transitions.

For example, when a user renders a virtual sculpture in a living room, the optimization module 222 dynamically scales the sculpture to realistic proportions relative to nearby furniture, ensures that the sculpture rests on the detected floor, and partially occludes the sculpture behind a physical table when required. The module continuously updates the parameters as the user changes viewpoint, to ensure perceptual coherence of the mixed reality scene.

In some embodiments, the optimization module 222 performs depth-based scaling of virtual elements using real-time measurements from a depth sensor or LiDAR sensor. For instance, if a virtual annotation is projected on a wall, the annotation automatically enlarges as the user 102 moves closer to the wall and shrinks when the user moves away, to maintain proportional realism.

In some embodiments, the optimization module 222 performs occlusion handling by detecting real-world objects captured by the depth sensor or LiDAR. In addition, the optimization module 222 modifies the rendering order of the one or more virtual elements. For example, a virtual ball rendered behind a physical chair remains hidden from the user’s view until the ball moves into visible space, to mimic natural visual occlusion. The real-time depth-based scaling of the one or more virtual elements is done using distance data derived from the LiDAR or the depth sensors. When the communication device 104 detects proximate physical surfaces, the one or more virtual elements are scaled or repositioned to maintain accurate spatial proportions relative to the physical environment. Additionally, the occlusion handling is achieved by analyzing depth layers captured by the depth sensor to determine visibility order of the physical and the virtual elements. The determined visibility order ensures that the digital objects appear naturally behind or in front of real-world elements to enhance depth realism and spatial consistency.

In some embodiments, the optimization module 222 reduces jitter and instability in MR visualization caused by abrupt device movement. The optimization module 222 dynamically lowers rendering fidelity by reducing polygon counts or applying temporal smoothing filters during periods of high motion detected by accelerometer and gyroscope sensors. Once stability is restored, the module automatically increases rendering fidelity to maximize visual realism.

In some embodiments, the optimization module 222 performs threshold-based optimization by triggering recalculation of rendering parameters only when sensor data changes exceed a pre-defined threshold. For example, small and insignificant device movements below the threshold are ignored for conserving computational resources and extending battery life while maintaining rendering accuracy.

In some embodiments, the optimization module 222 integrates predictive motion tracking by estimating probable device movements based on historical accelerometer and gyroscope data. For example, if the communication device is consistently moving in a forward direction, the optimization module 222 pre-adjusts the position and perspective of virtual elements to account for anticipated movement, reducing latency and improving responsiveness.

In one embodiment, the predictive motion tracking is applied by analyzing the historical accelerometer and gyroscope data to estimate probable device movement patterns. Based on the predictive estimation, the computing system 106 pre-adjusts the one or more virtual elements to compensate for upcoming spatial transitions. The pre-rendering technique minimizes motion lag, reduces recalculation overhead, and allows for seamless transitions during user movement within the mixed reality experience.

In one embodiment, the modular mixed reality engine 108 employs a threshold-based optimization mechanism for adaptive rendering. A re-rendering event is triggered only when the sensor data indicates a pre-defined threshold change in one or more parameters such as device position, orientation, or depth values. The pre-defined threshold change is determined based on calibration profiles, sensor accuracy ranges, and user experience benchmarks that define the minimum perceptible variation in spatial context requiring graphical update. The re-rendering refers to selectively updating one or more portions of the mixed reality scene affected by the detected change, rather than regenerating the entire scene frame. Similarly, the recalculations refer to computational processes associated with the spatial mapping, the object placement, and the depth alignment that are repeated only when threshold conditions are met. The approach minimizes redundant computation, ensures efficient utilization of hardware resources, and maintains stable frame performance during real-time mixed reality rendering.

In some embodiments, the optimization module 222 applies adaptive rendering fidelity control by dynamically tuning texture resolution, polygon density, and shading quality based on real-time sensor-derived device motion. For instance, when rapid rotational motion is detected, the module reduces shading complexity, whereas during stable conditions, the module restores high-fidelity textures and shadows.

In some embodiments, the optimization module 222 employs multi-sensor fusion to enhance robustness of optimization decisions. For example, GPS data can confirm user location, accelerometer data indicates linear motion, and gyroscope data confirms rotational motion, enabling the module to adjust MR rendering with higher accuracy and consistency.

In some embodiments, the optimization module 222 ensures continuity of user experience by maintaining spatial anchoring of virtual elements despite changes in environmental context. For example, when a user 102 enters a darker environment where camera performance deteriorates, the optimization module 222 shifts reliance to LiDAR or inertial sensors to maintain virtual object placement with minimal drift.

In some embodiments, the execution of the stored instructions causes a hardware-level adaptation of the rendering parameters and the sensor data processing across the one or more processors, the memory 204, and the plurality of embedded sensors 104a of the communication device 104. The hardware-level adaptation dynamically calibrates rendering frame rates, memory access bandwidth, and sensor polling frequency based on real-time environmental feedback. The adaptive process enables efficient distribution of computational tasks, ensuring that the sensor data is processed with minimal delay and that rendering pipelines remain optimized for the real-time responsiveness. Consequently, the coordination between the hardware components improves data throughput efficiency, reduces real-time rendering latency, and enhances the mixed reality synchronization accuracy between the virtual and the physical objects.

In some embodiments, the computing system 106 is implemented through hardware-level cooperation between the processor 202, the memory 204, the plurality of embedded sensors 104a, and a display unit of the communication device 104. The hardware components collectively enable the modular mixed reality engine 108 to dynamically acquire, process, and synchronize the real-time spatial data with the virtual rendering operations. The processor 202 coordinates concurrent execution of the plurality of mixed reality modules 110 to distribute computational workloads across sensor processing, context recognition, and rendering subsystems. The cooperation among hardware components allows the computing system 106 to achieve low-latency data transfer and adaptive load balancing, for reducing computation latency and maintaining stable frame rates during the mixed reality content rendering.

The plurality of embedded sensors 104a, such as inertial measurement sensors, depth sensors, and environmental sensors, continuously provide the real-time spatial and the orientation data. The processor 202 interprets the sensor data to recognize the usage context and accordingly instructs the modular mixed reality engine 108 to dynamically select and load the one or more appropriate mixed reality modules. Each selected mixed reality module operates within the secure execution framework, isolating module-level computation threads to prevent interference and optimize runtime efficiency. The hardware-level interaction between the processor 202, the sensors 104a, and the display unit enables the real-time synchronization of sensor-driven input with rendered visual output. The hardware-level interaction ensures the accurate spatial alignment of the one or more virtual elements with the corresponding physical environment.

Furthermore, the memory 204 manages the real-time buffering of the sensor inputs and pre-rendered graphical data frames for enabling the seamless rendering updates without frame delay. The computing system 106 dynamically adjusts the rendering parameters, such as frame resolution, shading precision, and occlusion mapping, in response to variations in the sensor data and the spatial context. The hardware-level adaptation across the processor 202, the memory 204, and the display unit minimizes the computational overhead and ensures stable graphical performance. The hardware-software cooperation results in measurable technical effects, such as the reduced rendering latency, improved frame stability, enhanced spatial coherence, and the optimized real-time responsiveness.

Through hardware-level coordination between the processor 202, the plurality of embedded sensors 104a, and the display unit, the computing system 106 reduces sensor-to-render latency, increases frame stability, and enhances spatial synchronization accuracy between virtual and physical elements. Accordingly, the computing system 106 of the present invention enables optimized sensor integration, adaptive module loading efficiency, and improved real-time rendering throughput.

The one or more processors and the memory 204 cooperate with the plurality of embedded sensors 104a and the display hardware of the communication device 104 to achieve the real-time synchronization between the spatial data acquisition and the virtual rendering operations. The synchronization ensures that every rendered frame reflects the most recent sensor data and positional updates without perceptible lag. The processor 202 dynamically aligns the sensor sampling intervals with the rendering cycles. The memory 204 buffers the intermediate spatial data to prevent data loss during frame transitions. The tightly coupled data pipeline results in reduced rendering latency, minimized computational overhead, and enhanced real-time mixed reality performance, for providing seamless visual alignment between the digital and physical environments.

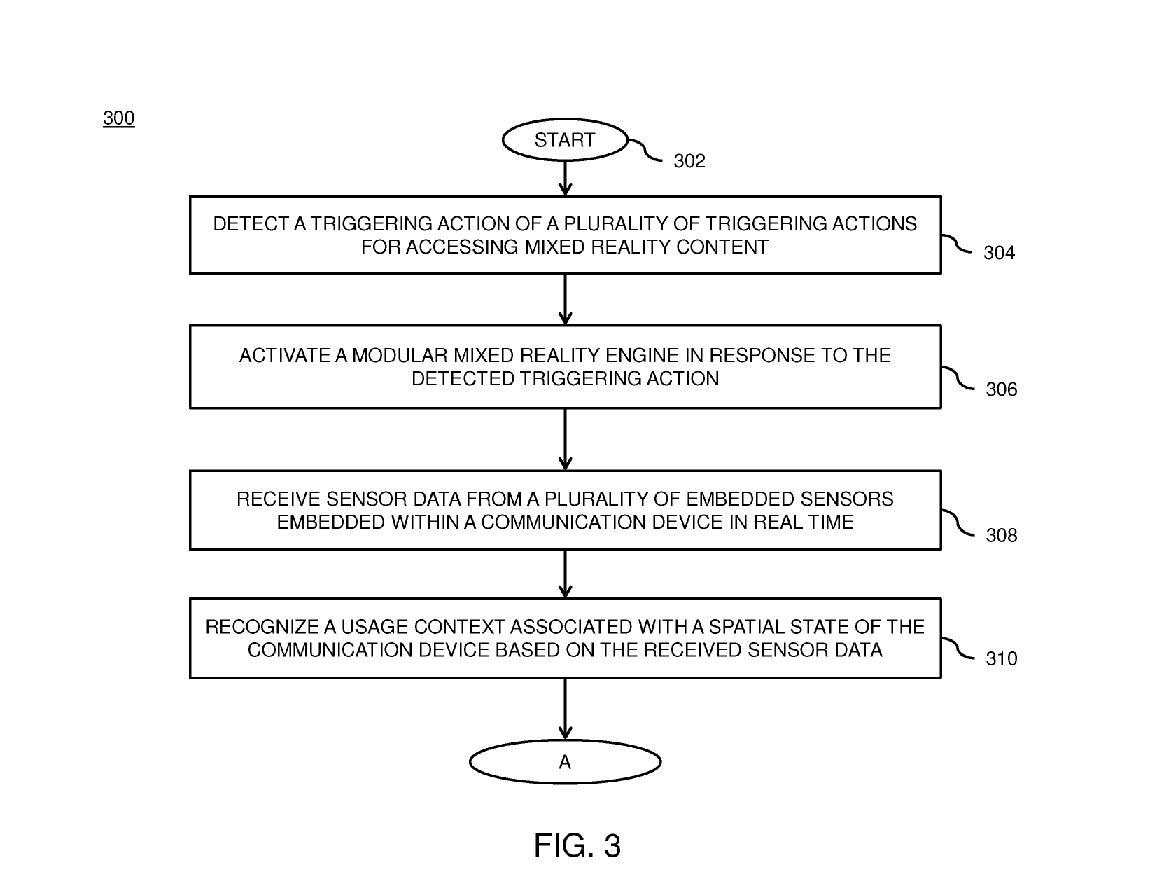

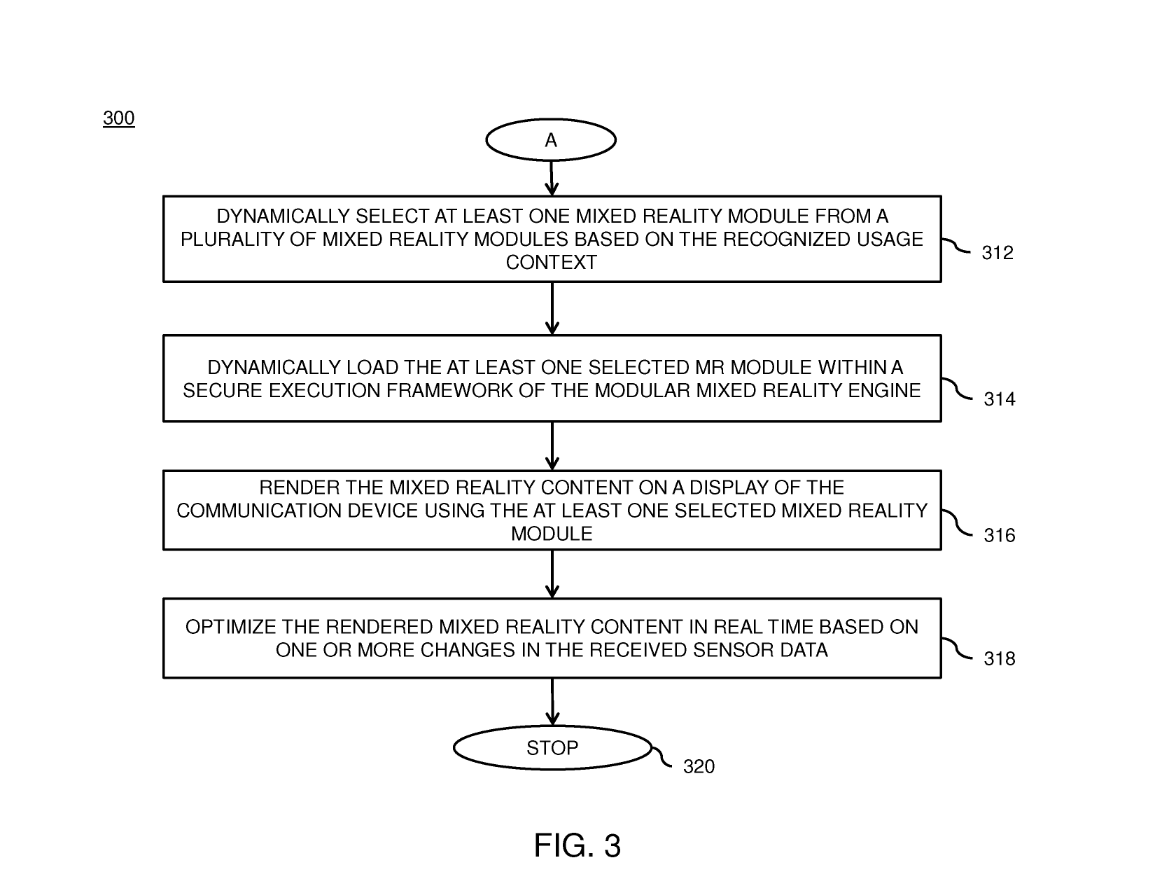

FIG. 3 illustrates a flow chart of a method 300 for harmonizing the digital objects with the physical environment in real time, in accordance with various embodiments of the present disclosure. It may be noted that the description of the flowchart 300 refers to FIG. 1, and FIG. 2. The working and functioning may be read from the description of FIG. 1, and FIG. 2.

The flowchart 300 initiates at step 302. At step 304, the method includes detecting a triggering action of a plurality of triggering actions for accessing mixed reality (MR) content on the communication device 104. In some embodiments, the plurality of triggering actions includes at least scanning the quick response (QR) code, detecting the near-field communication (NFC) tag, selecting the hyperlink, receiving the voice input, and recognizing the gesture input. Each of the triggering actions provides a platform-independent mechanism for initiating access to the mixed reality content without requiring device-specific configurations.

At step 306, the method includes activating the modular mixed reality engine 108 in response to the detected triggering action. The activation initializes the transient runtime environment and prepares the computing system 106 to dynamically load the suitable modules of the plurality of mixed reality modules 110.

At step 308, the method includes receiving, in real time, sensor data from the plurality of embedded sensors 104a embedded within the communication device 104. In some embodiments, the plurality of embedded sensors 104a includes at least one of an accelerometer, a gyroscope, a depth sensor, a LiDAR sensor, and a GPS sensor. The sensor data streams are synchronized using timestamp alignment, and data fusion algorithms such as Kalman filtering are applied to maintain consistency in device state estimation.

At step 310, the method includes recognizing the usage context associated with the spatial state of the communication device 104 based on the received sensor data. In some embodiments, the usage context includes at least one of the linear movement detected by the accelerometer, the rotational movement detected by the gyroscope, the spatial geometry detected by the LiDAR sensor, or the geolocation detected by the GPS sensor. The recognized context is used to determine the suitability of rendering parameters and select the appropriate one or more modules.

At step 312, the method includes dynamically selecting the at least one mixed reality module from the plurality of mixed reality modules 110 based on the recognized usage context. In some embodiments, the plurality of mixed reality modules 110 includes at least the motion tracking module, the environment mapping module, the spatial alignment module, and the occlusion handling module. For example, the spatial alignment module may be selected when planar surfaces are detected, while the occlusion handling module may be selected when depth data reveals overlapping physical and virtual objects.

At step 314, the method includes dynamically loading the at least one selected mixed reality module within the secure execution framework of the modular mixed reality engine 108. The secure execution framework is instantiated as the sandboxed runtime environment that ensures both performance and data security. In some embodiments, the dynamic loading of the at least one selected module of the plurality of mixed reality modules 110 is triggered when compatibility with device resources has been evaluated. The device resources may include CPU, GPU, and memory availability. Also, the dynamic loading leverages the instant application mechanism to enable temporary execution without requiring installation.

At step 316, the method includes rendering the mixed reality content on the display of the communication device 104 using the at least one selected mixed reality module. The rendering includes the superimposition of the one or more virtual elements onto the real-time view of the physical environment. In some embodiments, the rendering includes blending the two-dimensional alpha channel video overlay with the three-dimensional digital objects in the spatial alignment determined by the sensor data. For example, a transparent promotional video may be overlaid on a wall surface while simultaneously rendering an interactive 3D object on a table surface.

At step 318, the method includes the optimization of the rendered mixed reality content in real time based on the one or more changes in the received sensor data. In some embodiments, the optimizing includes at least one of adjusting the scale, the position, the orientation, the depth alignment, or the occlusion state of the one or more virtual elements relative to the physical environment. For example, a virtual furniture object is dynamically scaled when the communication device moves closer, its occlusion state is updated when a physical table partially blocks it, and its orientation is corrected when the communication device rotates.

In one embodiment, the optimization includes synchronizing the one or more virtual elements with the translational and the rotational device movements to maintain spatial anchoring. The optimization ensures that the one or more virtual elements are spatially anchored to the physical environment. Additionally, the optimization is triggered upon detecting the pre-defined threshold change in the sensor data to minimize unnecessary recalculations.

In some embodiments, the method includes applying the predictive motion tracking by estimating the probable device movement based on the historical accelerometer and the gyroscope data. The mixed reality content is pre-adjusted based on the predictions for reducing the latency during rapid transitions.

In an embodiment of the present disclosure, the optimization incorporates the stabilization feedback from the optical image stabilization (OIS) or the electronic image stabilization (EIS) subsystems of the communication device 104. The feedback ensures reduced jitter and improved spatial anchoring of the one or more virtual elements during abrupt motion.

The execution of the stored instructions enables the hardware-level cooperation among the processor 202, the non-transitory memory 204, the plurality of embedded sensors 104a, and the display hardware of the communication device 104 to achieve the real-time synchronization between the sensor data processing and the virtual rendering operations. The hardware components collectively adapt the rendering parameters, data flow priorities, and sensor polling frequencies based on the real-time environmental variations. The hardware-level adaptation and coordination enhance the efficiency of data throughput and enable seamless integration of sensor fusion with the adaptive rendering workflows. As a result, the computing system 106 minimizes computation latency, reduces real-time rendering delays, and maintains consistent frame stability. The cooperative functioning of these components ensures accurate spatial coherence between digital and physical elements, for enabling optimized resource utilization, enhanced synchronization accuracy, and improved real-time mixed reality performance.

In one embodiment, execution of the computer-executable instructions by the one or more processors improves operation of the communication device 104 by enabling real-time fusion of data obtained from the plurality of embedded sensors 104a. The sensor fusion enables the communication device 104 to determine spatial geometry, motion dynamics, and orientation context simultaneously, which in turn improves accuracy of the mixed reality (MR) content rendering.

The hardware-level coordination among the processor 202, the memory 204, the display hardware, and the plurality of embedded sensors 104a enables concurrent computation of the sensor data and graphical updates. Such coordination reduces the computational latency, enhances frame stability, and maintains consistent spatial alignment between the one or more virtual elements and one or more physical elements even during rapid user or device motion. The improved hardware-level efficiency reduces the number of rendering cycles required for real-time updates to minimize system resource consumption and maintain the rendering fidelity.

The flowchart 300 ends at step 320. The described steps collectively enable the real-time harmonization of the digital objects with the physical environment.

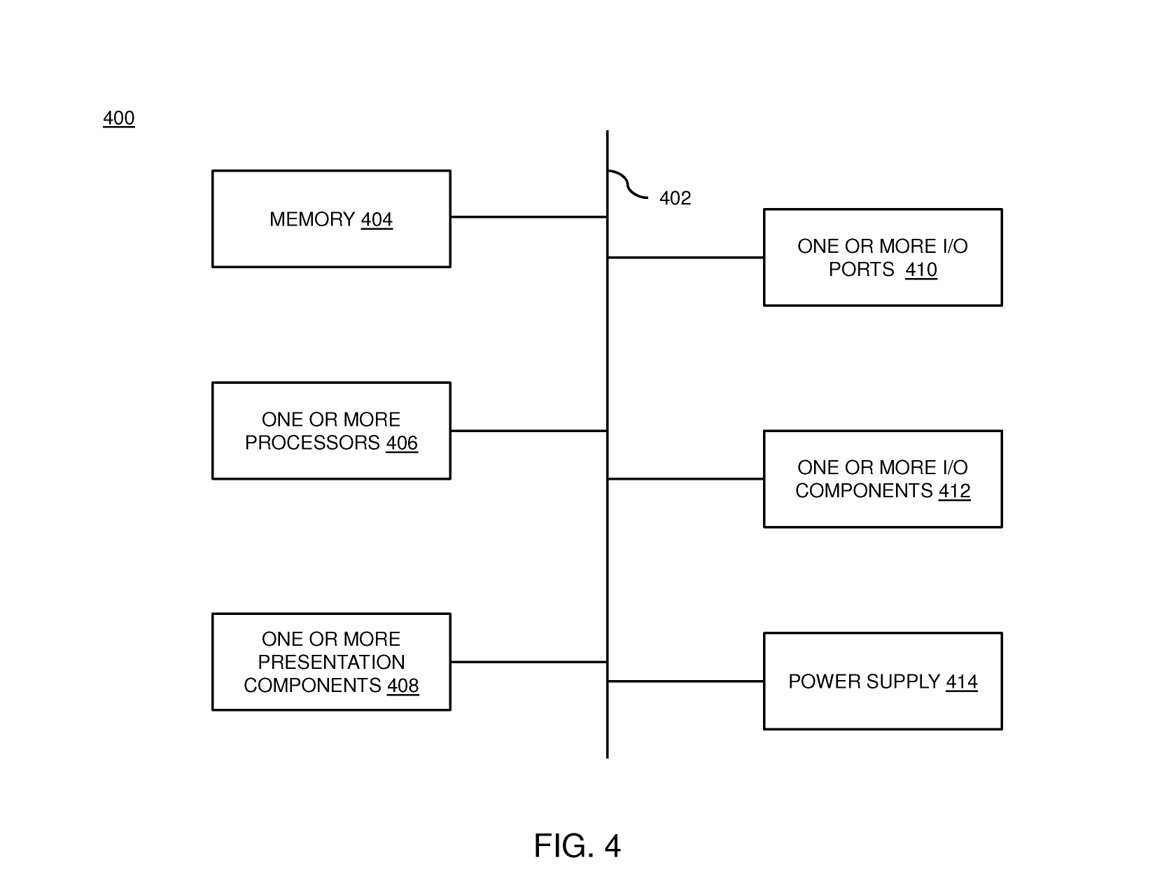

FIG. 4 illustrates a block diagram of an exemplary computing device 400 configured for executing the rendering of mixed reality (MR) content, in accordance with various embodiments of the present disclosure. The computing device 400 is representative of the communication device 104 or any computing entity configured to operate the modular mixed reality engine 108 and its associated modules. The computing device 400 is implemented as a non-transitory computer-readable storage medium that stores instructions for harmonizing digital objects with a physical environment in real time.

The computing device 400 includes a bus 402 that directly or indirectly couples the following hardware components: a memory 404, one or more processors 406, one or more presentation components 408, one or more input/output (I/O) ports 410, one or more input/output (I/O) components 412, and a power supply 414. The bus 402 represents one or more communication channels, such as an address bus, a data bus, or a combination thereof, for enabling communication between the device components.

In practice, the delineation between various components may not be strict, and several elements may overlap in function. For example, a presentation component such as a display device may also be considered an I/O component, and a processor may incorporate internal memory. The depiction in FIG. 4 is therefore illustrative and not limiting, serving as a logical representation of device components that collectively enable MR rendering functionality.

The non-transitory computer-readable storage medium corresponds to a tangible hardware element configured to store computer-executable instructions. The stored instructions, when executed by one or more processors, cause the computing system 106 to perform operations associated with the dynamic mixed reality content rendering, adaptive resource allocation, and real-time spatial synchronization. In some embodiments, the computing device 400 is configured to store one or more computer-executable instructions, data structures, and program components that are executed by one or more processors 406. The execution of the instructions causes the computing system 106 to perform the operations described herein. The non-transitory nature of the computing device 400 signifies that the storage medium is physically embodied, excluding transitory signal media such as carrier waves or propagated signals. Examples of such non-transitory storage media include, but are not limited to, solid-state drives (SSDs), flash memory, magnetic disks, optical disks, and read-only memory (ROM).

Furthermore, the computing device 400 stores machine-level instructions that, when executed by the one or more processors 406, cause the computing system 106 to perform the real-time acquisition of the sensor data, the context recognition, the dynamic selection and the loading of the at least one mixed reality module, and the harmonized rendering of the digital objects with the physical environment. The hardware-level execution of the instructions enables reduced sensor-to-render latency, improved frame stability, optimized processor utilization, and enhanced spatial alignment accuracy.

The computing device 400 typically includes a variety of computer-readable media accessible to the processor 406. The computer-readable media may be volatile or nonvolatile, removable or non-removable, and includes both computer storage media and communication media.

The computer storage media includes, but is not limited to, random access memory (RAM), read-only memory (ROM), electrically erasable programmable read-only memory (EEPROM), flash memory, hard drives, solid-state drives, optical disc drives such as compact disc-read only memory (CD-ROM) or digital versatile disc (DVD), magnetic cassettes, magnetic tapes, magnetic disks, or any suitable medium capable of storing data, instructions, or program modules.

The communication media embodies computer-readable instructions or data in a modulated data signal such as a carrier wave or another transport mechanism. Examples of communication media include wired communication (such as Ethernet or direct wired connections) and wireless communication (such as Wi-Fi, Bluetooth, infrared, radio frequency, or satellite-based channels).

The memory 404 provides a storage medium for computer-readable instructions that, when executed by the processor 406, enable functions such as detecting triggering actions, receiving sensor data, recognizing usage context, dynamically selecting and loading mixed reality modules 110, rendering digital objects, and optimizing mixed reality content in real time. The memory 404 may be implemented using removable or non-removable hardware devices such as flash storage, optical drives, or other solid-state or magnetic media.

The one or more processors 406 execute instructions stored in the memory 404 to perform operations required for MR rendering, including sensor fusion, spatial alignment, occlusion handling, and the predictive motion tracking. The processors 406 may include central processing units (CPUs), graphics processing units (GPUs), digital signal processors (DSPs), or specialized machine learning accelerators for executing MR-related computations efficiently.

The one or more presentation components 408 generate output perceptible to the user. Exemplary presentation components include a display screen for rendering mixed reality content, a speaker for spatial audio playback, and a vibration actuator for haptic feedback. These presentation components allow the digital objects and MR overlays to be perceived in spatial coherence with the physical environment.

The one or more I/O ports 410 enable communication between the computing device 400 and external devices, networks, or peripherals. Examples include Universal Serial Bus (USB) ports, HDMI interfaces, or wireless transceivers. The one or more I/O components 412 provide mechanisms for receiving user input or environmental data. Illustrative I/O components include a microphone, joystick, touch-sensitive interface, gamepad, the plurality of embedded sensors 104a, LiDAR sensor, depth sensor, and GPS sensor. These I/O components collectively contribute to capturing real-time context and enabling interactive MR experiences. The power supply 414 provides energy for device operation. The power supply 414 may be implemented as a rechargeable battery in portable communication devices such as smartphones or head-mounted displays, or as a wired power unit in stationary computing systems.

The arrangement of components in FIG. 4 is illustrative. Fewer or additional components may be included in different implementations, and functions described as being performed by one component may be distributed across multiple components. The computing device 400 is therefore representative of a flexible computing environment capable of supporting MR rendering across heterogeneous platforms.

The present invention is described hereinafter by various embodiments. The invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only, and are not intended to limit the scope of the claims. In addition, a number of system architectures are identified as suitable for various facets of the implementations. These system architectures are to be treated as exemplary and are not intended to limit the scope of the invention.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed is:

1. A computing system for harmonizing digital objects with a physical environment in real time, the computing system comprising:
one or more processors; and
a non-transitory memory storing computer-executable instructions that, when executed, cause the one or more processors to:
detect, at a communication device, a triggering action from a plurality of triggering actions for accessing mixed reality (MR) content;
activate a modular mixed reality engine in response to the detected triggering action;
receive, in real time, sensor data from at least one sensor of a plurality of embedded sensors integrated within the communication device;
recognize a usage context associated with a spatial state of the communication device based on the received sensor data;
dynamically select at least one mixed reality (MR) module from a plurality of mixed reality modules of the modular mixed reality engine based on the recognized usage context;
dynamically load, at the communication device, the at least one selected mixed reality module within a secure execution framework of the modular mixed reality engine;
render the mixed reality content on a display of the communication device using the at least one selected mixed reality module, wherein the rendering comprises superimposing one or more virtual elements onto a real-time view of the physical environment; and
optimize the rendered mixed reality content in real time based on one or more changes in the received sensor data, wherein the optimizing comprises at least one of adjusting a scale, position, orientation, depth alignment, or occlusion state of the one or more virtual elements relative to the physical environment, wherein the optimizing is triggered when a pre-defined threshold change is detected in the sensor data from the at least one sensor of the plurality of embedded sensors,
wherein the one or more processors and the non-transitory memory cooperate with the plurality of embedded sensors and a display hardware of the communication device to perform adaptive synchronization of spatial data and rendering operations, reducing frame latency, increasing throughput efficiency, and improving real-time spatial accuracy for mixed reality content visualization.

2. The computing system of claim 1, wherein the plurality of embedded sensors comprises at least one of an accelerometer, a gyroscope, a depth sensor, a LiDAR sensor, and a GPS sensor.

3. The computing system of claim 1, wherein the usage context comprises at least one of:
(a) a linear movement detected by an accelerometer,
(b) a rotational movement detected by a gyroscope,
(c) a spatial geometry detected by a LiDAR sensor, or
(d) a geolocation detected by a GPS sensor.

4. The computing system of claim 1, wherein the optimizing of the mixed reality content comprises synchronizing the one or more virtual elements with detected translational and rotational movement of the communication device to maintain spatial anchoring of the one or more virtual elements in the physical environment.

5. The computing system of claim 1, wherein the modular mixed reality engine utilizes the sensor data to minimize recalculations by adaptively re-rendering mixed reality content upon detecting the threshold change in the sensor data.

6. The computing system of claim 1, wherein the plurality of triggering actions comprises at least one of scanning a Quick Response (QR) code, detecting a near-field communication (NFC) tag, selecting a hyperlink, receiving a voice input, and recognizing a gesture input.

7. The computing system of claim 1, wherein the recognizing of the usage context comprises determining a type of movement pattern of the communication device based on at least one of an accelerometer data and gyroscope data.

8. The computing system of claim 1, wherein the usage context comprises a location context derived from GPS data to enable geolocation-based rendering of the mixed reality content.

9. The computing system of claim 1, wherein the optimizing of the mixed reality content comprises depth-based scaling of the one or more virtual elements using distance data captured by a depth sensor or a LiDAR sensor.

10. The computing system of claim 1, wherein the optimizing comprises performing occlusion handling by detecting one or more objects in the physical environment through a LiDAR sensor or a depth sensor and adjusting rendering order of the one or more virtual elements.

11. The computing system of claim 1, wherein the optimizing comprises adjusting rendering fidelity of the mixed reality content based on sensor-derived device motion to reduce jitter during transitions.

12. The computing system of claim 1, wherein the dynamic loading of the at least one mixed reality module comprises prioritizing loading of the plurality of mixed reality modules based on available device resources and thresholds of sensor stability.

13. The computing system of claim 1, wherein the one or more processors are operable to perform predictive motion tracking by estimating a probable movement of the communication device based on historical data from at least one of an accelerometer sensor and a gyroscope sensor, wherein the mixed reality content is pre-adjusted based on the predicted motion tracking.

14. The computing system of claim 1, wherein the rendering comprises blending a two-dimensional alpha channel video overlay with three-dimensional digital objects in spatial alignment determined by the sensor data.

15. The computing system of claim 1, wherein the plurality of mixed reality modules comprises at least one of a motion tracking module, an environment mapping module, a spatial alignment module, and an occlusion handling module.

16. A computer-implemented method executed by one or more processors of a computing system for harmonizing digital objects with a physical environment in real time, the computer-implemented method comprising:
detecting, at a communication device, a triggering action from a plurality of triggering actions for accessing mixed reality (MR) content;
activating a modular mixed reality engine in response to the detected triggering action;
receiving, in real time, sensor data from at least one sensor of a plurality of embedded sensors integrated within the communication device;
recognizing a usage context associated with a spatial state of the communication device based on the received sensor data;
dynamically selecting at least one mixed reality (MR) module from a plurality of mixed reality modules of the modular mixed reality engine based on the recognized usage context;
dynamically loading, at the communication device, the at least one selected mixed reality module within a secure execution framework of the modular mixed reality engine;
rendering, on a display of the communication device, the mixed reality content using the at least one selected mixed reality module, wherein the rendering comprises superimposing one or more virtual elements onto a real-time view of the physical environment; and
optimizing the rendered mixed reality content in real time based on one or more changes in the received sensor data, wherein the optimizing comprises at least one of adjusting a scale, position, orientation, depth alignment, or occlusion state of the one or more virtual elements relative to the physical environment, and wherein the optimizing is triggered when a pre-defined threshold change is detected in the sensor data from the at least one sensor of the plurality of embedded sensors,
wherein execution of the computer-executable instructions by the one or more processors improves operation of the communication device by performing hardware-level coordination between the processor, memory, and the plurality of embedded sensors for real-time sensor fusion and adaptive rendering, reducing redundant computations, improving frame stability, and enhancing spatial coherence between the one or more virtual elements and physical elements in the environment

17. The computer-implemented method of claim 16, wherein the one or more processors are caused to execute the instructions that improve operation of the communication device by performing sensor-fusion-based synchronization across a processor, a memory, and the plurality of embedded sensors to achieve enhanced real-time responsiveness, reduced frame lag, and stable spatial alignment between the one or more virtual elements and the physical environment.

18. The computer-implemented method of claim 16, wherein the hardware-level coordination among the processor, the memory, and the plurality of embedded sensors enables parallelized computation of the sensor data and rendering parameters for an optimized data throughput, minimized latency, and improved frame coherence during the real-time mixed reality content rendering.

19. The computer-implemented method of claim 16, wherein the one or more processors execute an instruction for performing predictive motion tracking by estimating a probable movement of the communication device based on historical data from at least one of an accelerometer sensor and a gyroscope sensor, wherein the mixed reality content is pre-adjusted based on the predicted motion tracking.

20. A non-transitory computer-readable storage medium storing computer-executable instructions which, when executed by one or more processors of a computing device, cause the computing device to perform a method for harmonizing digital objects with a physical environment in real time, the method comprising:
detecting, at a communication device, a triggering action from a plurality of triggering actions for accessing mixed reality (MR) content;
activating a modular mixed reality engine in response to the detected triggering action;
receiving, in real time, sensor data from at least one sensor of a plurality of embedded sensors integrated within the communication device;
recognizing a usage context associated with a spatial state of the communication device based on the received sensor data;
dynamically selecting at least one mixed reality (MR) module from a plurality of mixed reality modules of the modular mixed reality engine based on the recognized usage context;
dynamically loading, at the communication device, the at least one selected mixed reality module within a secure execution framework of the modular mixed reality engine;
rendering the mixed reality content on a display of the communication device using the at least one selected mixed reality module, wherein the rendering comprises superimposing one or more virtual elements onto a real-time view of the physical environment; and
optimizing the rendered mixed reality content in real time based on one or more changes in the received sensor data, wherein the optimizing comprises at least one of adjusting a scale, position, orientation, depth alignment, or occlusion state of the one or more virtual elements relative to the physical environment, and wherein the optimizing is triggered when a pre-defined threshold change is detected in the sensor data from the at least one sensor of the plurality of embedded sensors,
wherein execution of the stored instructions causes hardware-level adaptation of rendering parameters and sensor data processing across the one or more processors, memory, and the plurality of embedded sensors of the computing device, improving data throughput efficiency, reducing rendering latency, and increasing synchronization accuracy between virtual and physical elements.
